(19) United States
(12) Patent Application Publication
(10) Pub. No.: US 2009/0298379 A1
(43) Pub. Date: Dec. 3, 2009

(54) TOY SNOWBOARD

(76) Inventors: Joshua D. Henson, Manhattan Beach, CA (US); David Sheltman, Rancho Palos Verde, CA (US)

Correspondence Address: CANTOR COLBURN, LLP, 20 Church Street, 22nd Floor, Hartford, CT, 06103, US

(21) Appl. No.: 12/476,086

(22) Filed: Jun. 1, 2009

Related U.S. Application Data
(60) Provisional application No. 61/058,204, filed on Jun. 2, 2008.

(51) Int. Cl. A63H 33/00; B23P 11/00

(52) U.S. Cl. 446/26; 29/428

(57) ABSTRACT

A hand-driven toy is disclosed herein. The hand-driven toy includes a snowboard having an upper surface and a lower surface; a pair of bindings fixedly secured to the upper surface each of the pair of bindings defining a boot cavity; and a pair of boot members each being configured to be releasably secured to the boot cavity of one of pair of bindings, and each of the pair of boot members having a finger opening.

### CROSS REFERENCE TO RELATED APPLICATIONS

This application claims the benefit of U.S. Provisional application, Ser. No. 61/058,204, filed Jun. 2, 2008, the contents of which are incorporated herein by reference thereto.

### BACKGROUND

Exemplary embodiments of the present invention relate to a hand-driven toy and in particular a toy manipulated by the fingers of a player or user.

Children's toys have included miniature cars, boats, trains, etc. wherein the user's imagination provides for hours of extended play and enjoyment.

Accordingly, it is desirable to provide miniature toys that can be manipulated by the fingers of an individual wherein the toy is representative of current activities that are of interest to the user.

### SUMMARY OF THE INVENTION

In one embodiment, a hand-driven toy is provided. The hand-driven toy includes a snowboard having an upper surface and a lower surface; a pair of bindings fixedly secured to the upper surface each of the pair of bindings defining a boot cavity; and a pair of boot members each being configured to be releasably secured to the boot cavity of one of the pair of bindings, and each of the pair of boot members having a finger opening.

In another embodiment, a method for providing a hand-driven toy is disclosed, the method comprising: rotatably mounting a pair of bindings to an upper surface of a snow board; and releasably securing a pair of boot members into the pair of bindings each of the pair of boot members having a finger opening.

### BRIEF DESCRIPTION OF THE DRAWINGS

Other features, advantages and details appear, by way of example only, in the following description of embodiments, the description referring to the drawings in which:

FIGS. 1-2 are perspective views of the hand-driven toy in accordance with an exemplary embodiment of the present invention;

FIGS. 2A is a side elevational view of the hand-driven toy;

FIG. 2B is an end view of the hand-driven toy;

FIG. 2C is a top view of the hand-driven toy;

FIGS. 2D-5D illustrate component parts of the hand-driven toy of an exemplary embodiment of the present invention;

FIGS. 6-7B illustrates a case for the hand-driven toy of an exemplary in accordance with an exemplary embodiment of the present invention;

FIG. 8 illustrates a case in accordance with an alternative exemplary environment of the present invention;

FIGS. 9-9D illustrate an alternative exemplary embodiment of the present invention; and

FIGS. 10-13D illustrate alternative exemplary embodiments of the present invention.

### DETAILED DESCRIPTION

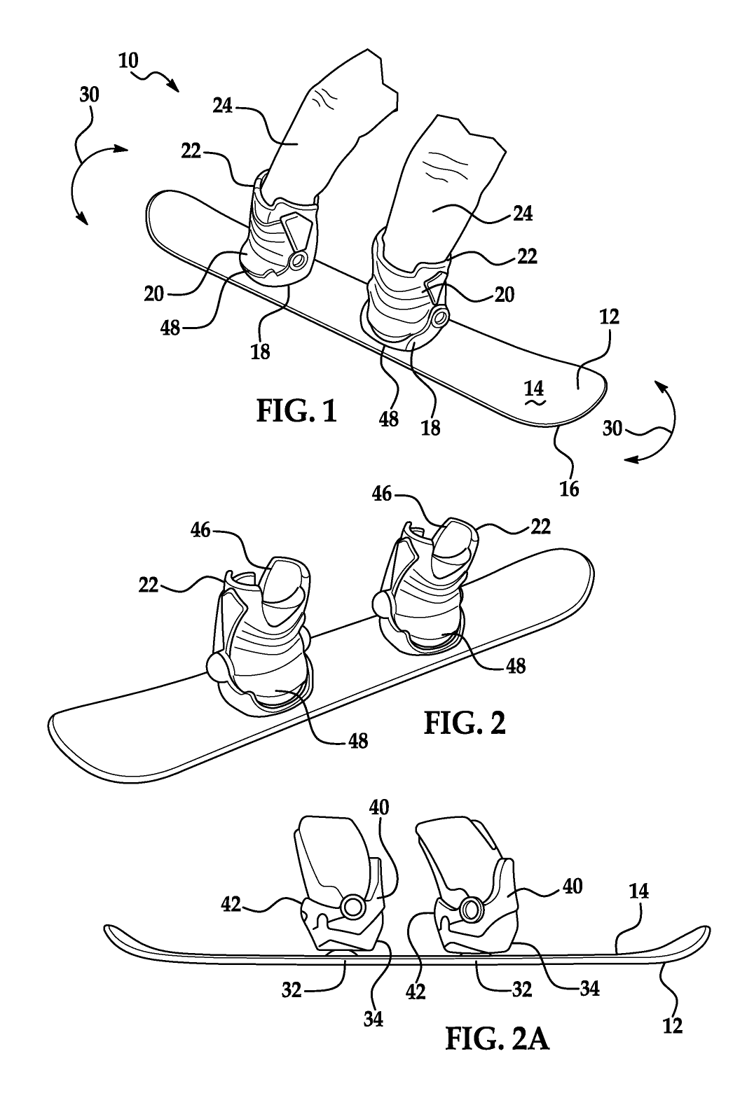

In accordance with exemplary embodiments of the present invention a hand-driven toy is provided. In one embodiment and referring now to FIG. 1 one non-limiting example of a hand-driven toy 10 is illustrated. The hand-driven toy includes a miniature snowboard 12 having an upper surface 14 and a lower surface 16. Mounted to the upper surface of the snowboard are a pair of bindings 18. Bindings 18 are configured to releasably receive a pair of boots or boot members 20 therein. Each of the bindings defines a boot cavity 19 configured to releasably receive a portion of one of the boot members therein.

As illustrated, each of the pair of boot members has a finger opening 22. The finger openings are configured to receive a distal end of an individual's fingers 24 such that a tip portion of one of the individual's fingers can be inserted into the finger opening of the boot member in order to play with the toy snowboard. As shown, a pair of fingers of a user are inserted into the pair of finger openings of the boot members and the finger openings are configured such that the fingers are capable of being inserted therein and frictional engagement of an interior surface of the finger opening is provided such that the toy snowboard will be retained on the users fingers when lifted from a surface.

Accordingly, a user can insert their fingers into the finger openings and slide the snowboard along a surface wherein the lower surface engages or slides along a play surface. It being understood however, that the frictional engagement of the individual's fingers within the finger openings is releasable or in other words not permanent. As used herein, finger opening refers to an opening having an interior dimension large enough to receive the fingers of an individual. Furthermore, the individual's fingers may be those of a child, adolescent, teen and/or adult. Accordingly, the size of the finger opening may vary as long as it is sufficiently large enough to receive, frictionally engage and ultimately release a distal end of an individual's fingers therein. In addition, the snowboard is sized to conform to the boot member size such that the length and width of the snowboard have a ratio similar to that of a snowboard that is actually rode by a user (e.g., a standard or non-miniature snowboard).

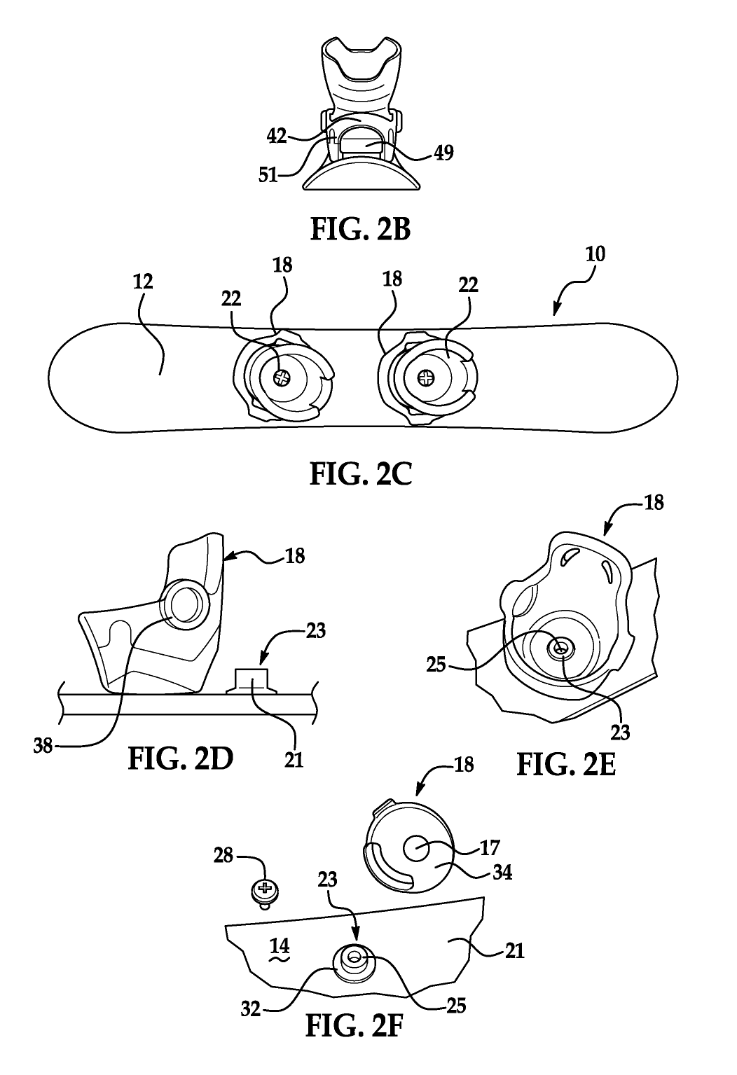

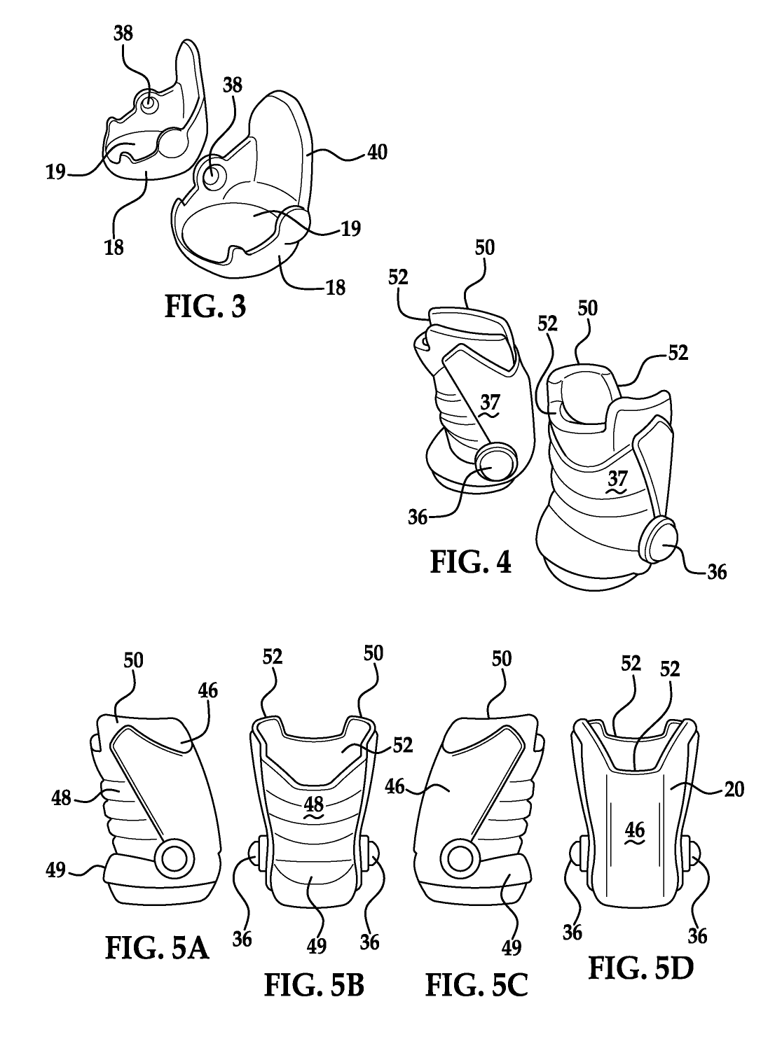

Referring now to FIGS. 2-5D and in accordance with one non-limiting exemplary embodiment, the bindings are rotatably secured to the upper surface of the snowboard by for example a fastener 28 (e.g., screw, rivet, bolt, etc.) that engages a complementary opening in the snowboard. Fastener 28 will have a shaft portion passing through an opening in a bottom portion of the binding, wherein the fastener further comprises a head portion or other equivalent member secured to the shaft portion that does not pass through the opening in the bottom of the binding. Accordingly, the bindings when secured to the upper surface of the snowboard through fastener 28 are capable of rotational movement in the direction of arrows 30. Moreover, each of the bindings are rotatably secured such that rotation of the bindings may be in opposite directions. For example, the user may move their index finger upward while simultaneously moving their middle finger of the same hand downward or alternatively move one finger upward or downward while maintaining the other finger inserted into the boot member stationary. It is also understood that any pair of fingers may be inserted into the finger openings of the boot members (e.g., thumb, index, middle, ring and pinky). Alternatively, the bindings can be fixedly secured to the snowboard such that no rotational movement is allowed. In other alternative exemplary embodiments of the present invention other releasable means for securing the bindings to snowboard are provided. In still another alternative exemplary embodiment the bindings may be permanently but rotatably secured to the snowboard and are configured to releasably receive and secure the boots therein.

In yet another alternative embodiment, the bindings are mounted to or on top of a protrusion 32 extending away from the upper surface of the snowboard. Accordingly, a lower surface 34 of the bindings is in a facing spaced relationship with respect to the upper surface of the snowboard thus, the lower surface only makes contact with protrusion 32. Furthermore and in one embodiment, the surface area of protrusion 32 is substantially less than that of lower surface 34 such that there is less frictional engagement between protrusion 32 and lower surface 34 or in other words binding 18 is easily rotated once secured to the upper surface of the snowboard.

In addition and where necessary, the protrusion 32 provides an extended height (e.g., protrusion and width of the snowboard) for receipt of the fastener therein in order to provide securement of the bindings to the snowboard. As illustrated in FIGS. 2-5D each of the boot members has at least one fastener, feature or protrusion 36 that extends away from an exterior surface 37 of the boot member. The protrusion is configured to be received within any complementary opening 38 in the binding such that the boot member can be releasably secured to one of the bindings through an interference fit or engagement wherein protrusion or protrusions 36 engage openings 38. This will allow the boot members to be snap fitted or inserted into the bindings such that the same are retained therein for user play when the individual's fingers are inserted into the finger openings of the boot members.

In addition, and as illustrated in the FIGS., each of the bindings has a heel portion 40 and a toe portion 42. The toe portion and the heel portion of the binding are each configured to engage a respective heel portion 46 and toe portion 48 of the boot member. In one exemplary embodiment, each of the boot members comprises a pair of protrusions 36 depending away from opposite sides of the exterior surface of the boot member. Of course, numerous other configurations (e.g., number, size and location of protrusions may vary) are contemplated to be within the scope of exemplary embodiments of the present invention. In addition and in one non-limiting embodiment, an upper periphery 50 of the finger opening is configured to have a pair of recessed openings 52, which allow for angular movement of the individual's finger while it is inserted within the finger opening. Of course, other configurations are contemplated such as an upper periphery with no recessed openings or one or more recessed openings of the same or different configuration.

As illustrated in FIGS. 5A-5D, each of the boot members is also configured to have an angular configuration wherein at least the exterior surface corresponding to the toe portion and the heel portion is angularly configured such that the exterior surface of the heel portion and the toe portion is not at an orthogonal angle with respect to the bottom surface of the boot member. Of course, orthogonal angles are also contemplated to be within the scope of exemplary embodiment of the present invention.

In addition and in one alternative embodiment, the toe portion of the boot member has a protruding portion 49, which is received in an opening 51 defined by the toe portion of the binding (See for example FIG. 2B) alternatively, the toe portion of the binding defines another type of opening 51 (e.g., open on top see for example FIGS. 1, 2 and 3).

In one non-limiting example, the boot members and the bindings are manufactured out of an easily molded material such as plastics or equivalents thereof In addition, the snowboard is also manufactured out of an easily molded material such as a plastic or equivalents thereof.

FIGS. 2D-F illustrate binding 18 with an opening 17 configured to engage a shaft 21 of a mounting feature 23 secured to upper surface 14 of the snowboard 12, wherein shaft 21 has a threaded opening 25 ton engage threads of fastener 28 in order to allow for rotational securement of the binding to the snowboard as discussed above.

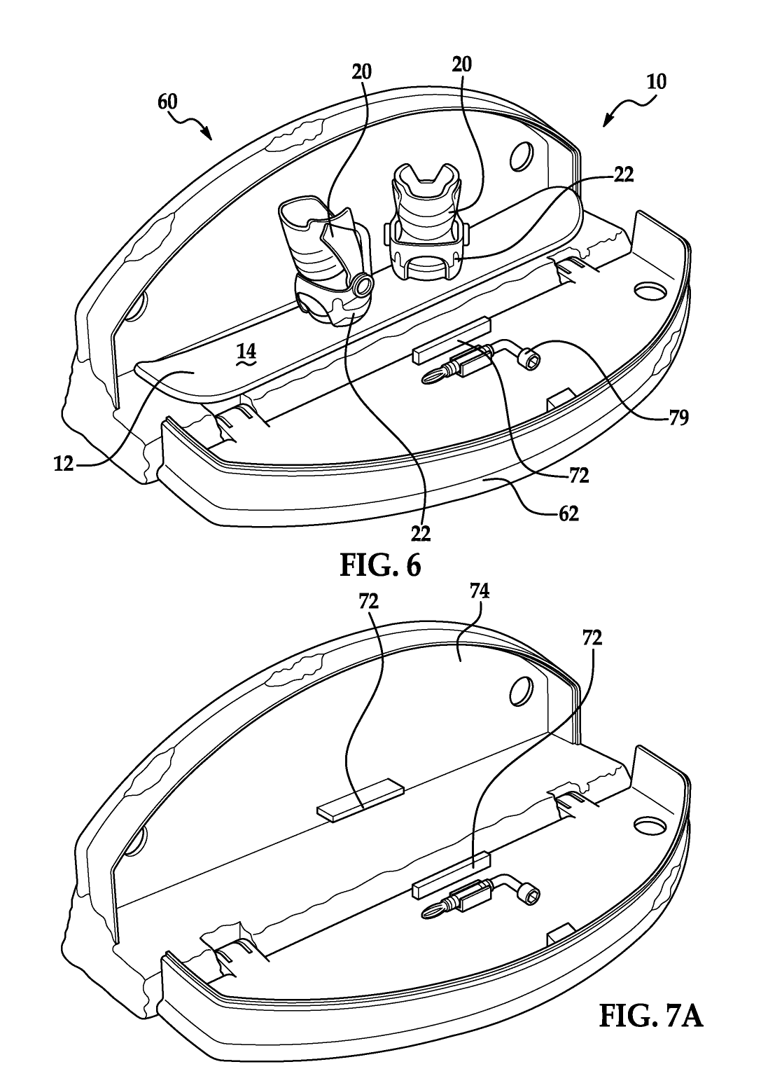

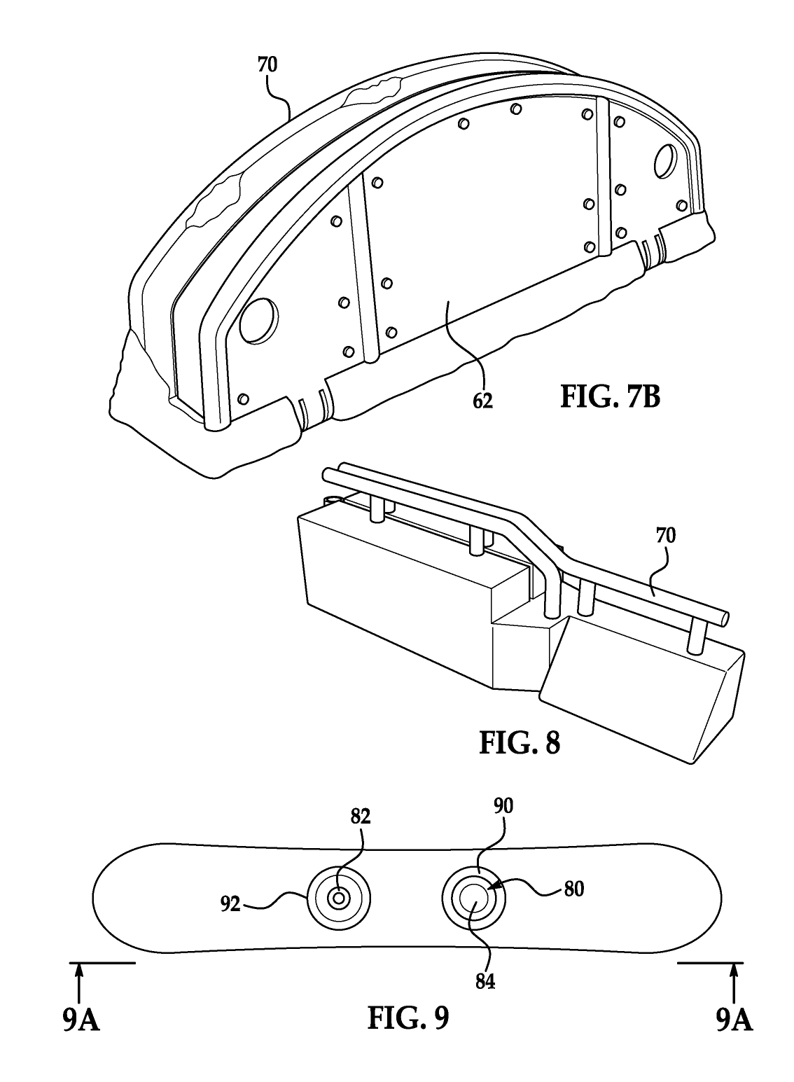

Referring now to FIGS. 6-7B, another exemplary embodiment of the present invention is illustrated. Here the toy snowboard is received within a case 60 having a door member 62 pivotally mounted thereto for movement between an open position (FIGS. 6 and 7A) and a closed position (FIG. 7B). In one exemplary embodiment the case is configured to define a miniaturized version of a terrain portion or surface 70 simulating terrain that a full-sized snowboard may traverse when manipulated by a user. As used herein, full-size snowboard is understood to refer to a snowboard that an individual stands on and rides. In one embodiment, the case provides a carrying case for the toy snowboard. For example, a retainment feature 72 is provided to engage a portion or edge of the snowboard when the snowboard is inserted within a cavity 74 defined by the case. In one embodiment and as illustrated, the case has a pair of retainment features 72 wherein one of the retainment features is integrally formed with the door member 62 such that when the door member is manipulated into the close position illustrated in FIG. 7B the toy snowboard is retained within the cavity of the case by the pair of retainment features integrally formed with each of the portions of the case.

In addition and in one particular embodiment, the case is also configured to releasably secure a tool 79. The tool is configured to engage the fasteners holding the bindings onto the snowboard for example, tool 79 may comprise a Philips head screwdriver and/or socket and/or any other equivalent device configured to engage a head portion of the fastener securing the bindings to the upper surface of the snowboard. Of course, other means for securing the bindings to the snowboard are contemplated to be within the scope of exemplary embodiments of the present invention wherein a simple snap fit or sliding engagement is provided and no special tools are required for securing the bindings to the snowboard.

FIG. 8 illustrates an alternative case 60 having an alternative terrain portion 70 upon which the toy snowboard may travel when manipulated by a user.

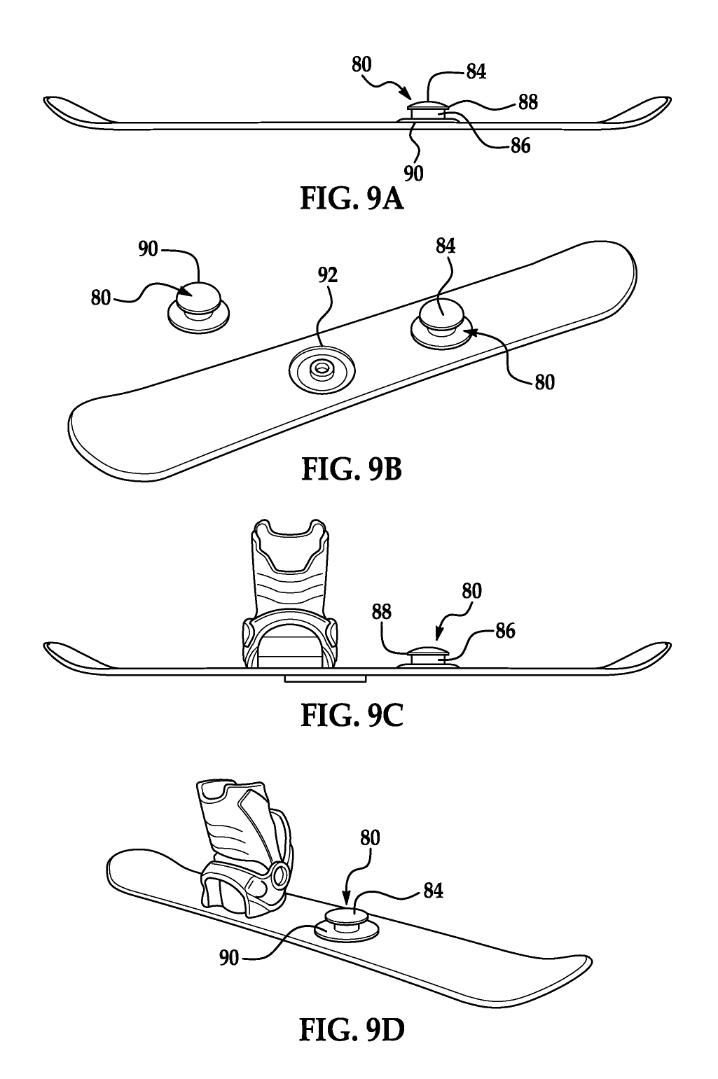

Referring now to FIGS. 9-13D other alternative exemplary embodiments of the present invention are illustrated. Here the upper surface 14 of the snowboard has a pair of mounting features 80 secured thereto. Mounting features 80 are secured to the upper surface 14 of the snowboard via a feature 82 and/or adhesive to secure the mounting features to the upper surface of the snowboard. Alternatively, only an adhesive or any other suitable securement means (e.g., welding, ultrasonic welding, integrally molding, and equivalents thereof, etc.) are provided to cause mounting feature 80 to depend away from the surface of the snowboard. In one non-limiting exemplary embodiment, mounting features 80 are secured to the snowboard after graphics have been applied to the upper surface of the snowboard via any suitable application process wherein the application process requires a generally flat surface (e.g., application of the graphics may require a generally flat surface for application of the graphics). Alternatively and where applications are provided they do not require a generally flat surface, mounting features 80 are integrally molded with the snowboard. In still another non-limiting embodiment, mounting features 80 provide a softer or harder material than that of the snowboard for example a material that is more durable for rotational movement of the bindings thereon.

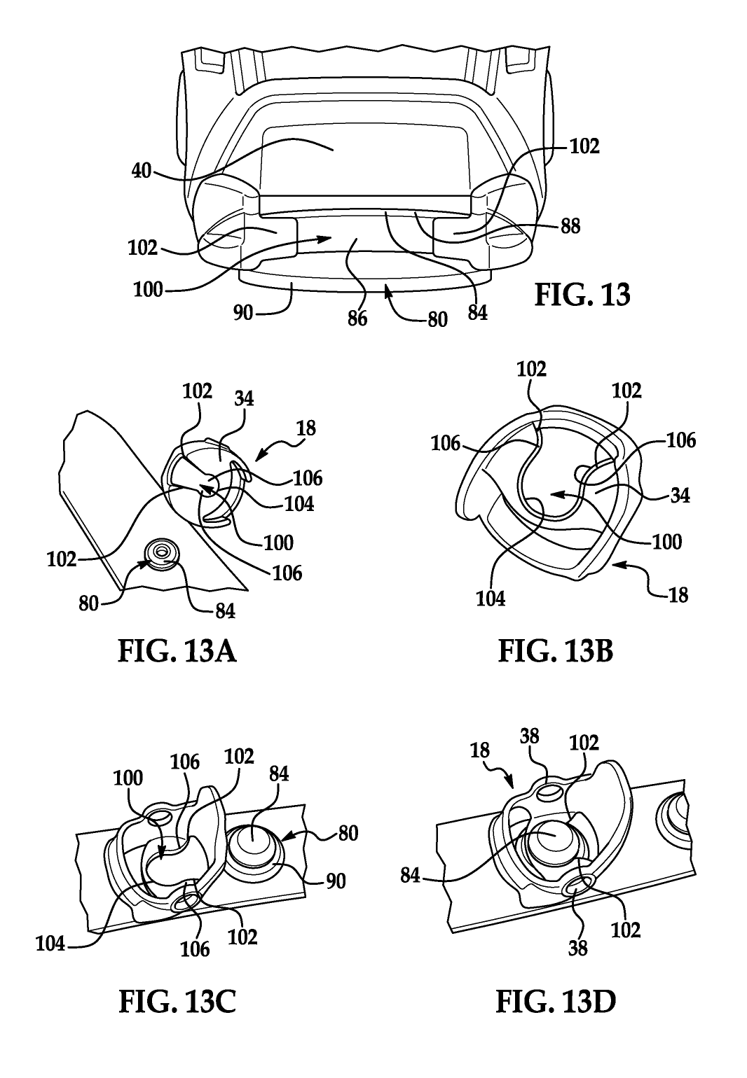

As illustrated, mounting feature 80 has an upper engagement portion 84 disposed away from the upper surface of the snowboard. The upper engagement portion is secured to a post member 86 such that an extending lip or edge portion 88 of upper engagement portion is provided. Furthermore, the post member 86 is secured to a base member 90, which is received within an opening or recess 92 on the upper surface of the snowboard. In one embodiment, the base member is received within opening 92 such that a surface or peripheral edge of base portion 90 is flush with an upper surface of the snowboard to facilitate securement of the snowboard bindings thereto. In yet another alternative, a portion of base portion extends above the surface of the snowboard (see at least FIGS. 13C and 13D) to provide a curved protruding surface for the bottom of the binding to rotate thereon while keeping the remaining bottom portions of the binding away from other surfaces of the snowboard to reduce frictional drag of the same and allow for ease of rotation. In one non-limiting embodiment, feature 80 is formed of a resilient material such as rubber and/or is coated such that there is a minimal amount of friction between feature 80 and the bottom of the binding.

In accordance with an exemplary embodiment of the present invention lip or edge portion 88 is configured to engage (e.g., slidably or otherwise) an opening in the snowboard binding as will be discussed herein. In one exemplary embodiment mounting feature 80 is fixedly secured to the snowboard via any suitable process (e.g., adhesives integrally molding, etc.). In order to releasably and pivotally secure the boots and bindings to the snowboard and as illustrated in FIGS. 11-13 the binding has an opening 100 disposed therein and accessible only on one side of the binding such that is configured to slidingly engage engagement portion 84 such that the binding cannot be vertically removed from the snowboard once the binding is secured to the engagement portion 84 by slidingly engaging the mounting feature in a generally horizontal direction with respect to an upper surface of the snowboard. Once slidably engaging the mounting portion the binding is rotatably secured to the upper surface of the snowboard. Of course, other configurations are contemplated wherein the binding is more fixedly secured or permanently secured to the snowboard wherein rotational movement of the same is still provided. In still yet another alternative exemplary embodiment, the bindings are removably secured to the snowboard via a removable fasteners such as screw or other equivalent item.

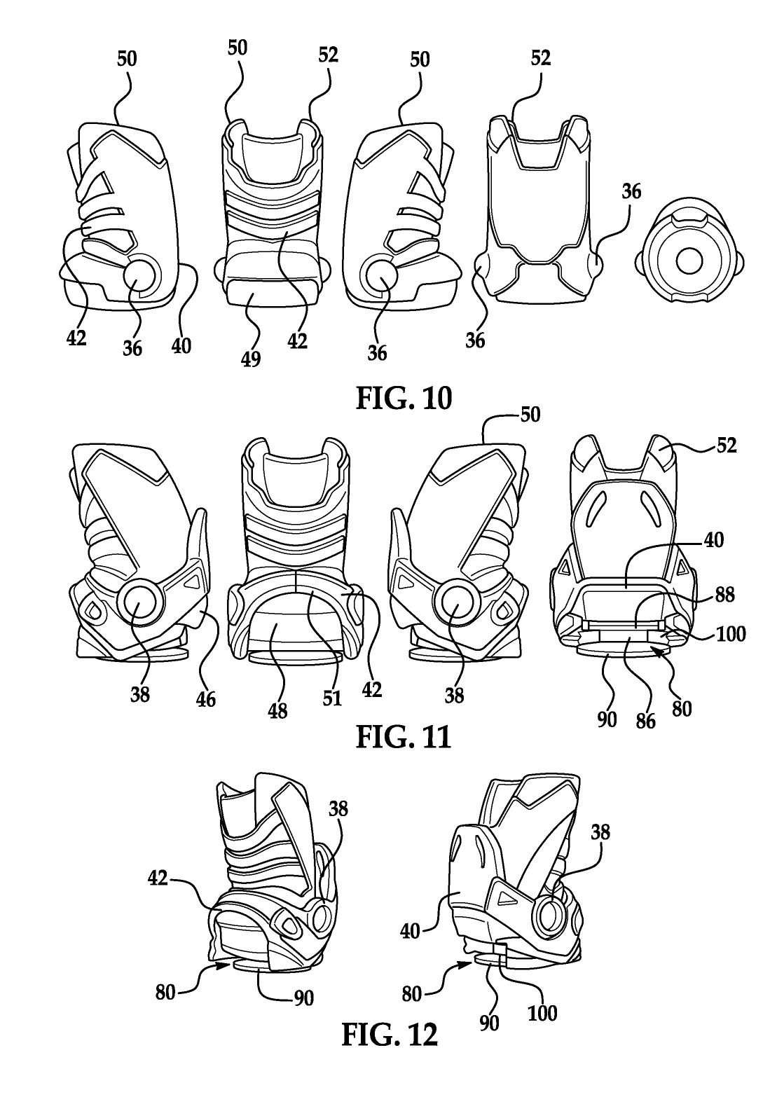

As illustrated in FIGS. 10-13D each of the bindings has a heel portion 40 and a toe portion 42. The toe portion and the heel portion of the binding are each configured to engage a respective heel portion 46 and toe portion 48 of the boot member. In one exemplary embodiment, each of the boot members comprises a pair of protrusions 36 depending away from opposite sides of the exterior surface of the boot member. In one exemplary embodiment the protrusions 36 are configured to engage openings 38 in the side walls of the bindings. Of course, numerous other configurations (e.g., size, configuration, location and number) of the protrusions are contemplated to be within the scope of exemplary embodiments of the present invention wherein releasable securement of the boots within the bindings is provided. In addition and in one non-limiting embodiment, an upper periphery 50 of the finger opening is configured to have a pair of recessed openings 52, which allow for angular movement of the individual's finger while it is inserted within the finger opening. Of course, other configurations are contemplated such as an upper periphery with no recessed openings or one or more recessed openings of the same or different configuration.

In addition and in one alternative embodiment, the toe portion of the boot member has a protruding portion 49, which is received in an opening 51 defined by the toe portion of the binding. As in the previous embodiments, boots 20 are releasably secured to the bindings by protrusions 36 engaging openings 37.

Furthermore and as discussed previously above, each binding has a receiving area located in the heel portion and defined by an opening 100 wherein one of the pair of mounting features 80 is slidably received therein, for example post portion or post member 86 slides within opening 100 while upper engagement portion 84 is received above opening 100 and base member 90 is received below opening 100. FIG. 12 which provides an enlarged view of a heel portion of a binding secured to a mounting member as well as a boot removably secured in the binding. In one exemplary embodiment, at least engagement portion 84 has a periphery that is larger than the periphery of opening 100. Alternatively, base portion 90 also has a periphery larger than the periphery of opening 100. In order to releasably secure the binding to the snowboard, opening 100 is slid horizontally across the snowboard such that post 86 is received within opening 100 while upper engagement portion 84 is disposed above the opening defined in the binding wherein the portion 88 provides a surface or shoulder upon which vertical removal of the binding is prevented however, rotational movement of the binding and accordingly the boot inserted therein is allowed. In other words, opening 100 provides a channel open on one side that allows the post to be inserted therein such that the binding is retained upon the snowboard and allows for rotational movement of the same without the binding being disengaged from the snowboard.

As illustrated in at least FIGS. 13A-13D opening 100 is further defined by an angled opening section having a pair of angled surfaces 102 and a curved portion or “C” shaped section 104 to facilitate the receiving and rotational securement of feature 80 to the binding by sliding the same into the opening 100 wherein an interface or feature 106 defined between section 104 and surface 102 is provided to snap fit or releasably engage the shaft or post 86 in opening 100 such that the binding is releasably and rotatably secured to the snowboard. Of course, other configurations for performing the same releasable and rotational securement of the binding to the snowboard are contemplated to be within the scope of exemplary embodiments of the present invention.

In an alternative exemplary embodiment, opening 100 can be located at the toe portion of the binding wherein mounting member and/or feature is slidably inserted through an opening located at the toe portion of the binding. In still another alternative exemplary embodiment, opening may extend completely through the binding from the toe portion to the heel portion wherein a central portion of the opening is configured to have features that narrow the size of the opening such that post 86 is removably and/or fixedly retained therein once binding 18 is slidably engaged upon the mounting member. In other words, opening 100 that extends through the binding has at least a pair of features configured to engage the post member of the mounting member as it slid within opening 100. In any of the aforementioned embodiments, opening 100 may be configured to have features that reduced the inner diameter or perimeter of the opening such that the same is configured to secure engage post 86 as it slid into opening past the features that reduce the inner diameter of the opening. Of course, opening 100 may be configured to engage other portions of the mounting member and exemplary embodiments of the present invention are not specifically limited to engaging post 86.

FIGS. 9C and 9D illustrate a binding and boot secured to the mounting feature 80 in accordance with an exemplary embodiment of the present invention. Accordingly, and as disclosed herein a toy snowboard is provided wherein a pair of mounting features or mounting members are secured to an upper surface of the snowboard such that a pair of bindings are removably and/or fixedly secured to the mounting feature such that the bindings are rotatably secured to the upper surface of the snowboard and a pair of boots with finger openings are provided. The boots with the finger openings have at least one protrusion to releasably engage an opening and/or feature disposed in a respective binding in order to provide removable securement of the boots within the bindings such that a user may place their fingers in the boots and simulate snowboarding with their fingers. Furthermore, the rotational securement of the bindings to the snowboard allow a user to manipulate their fingers inserted therein and thus rotate the snowboard to further simulate snowboarding with their fingers.

While the present invention has been described in terms of specific embodiments, it should be appreciated that the spirit and scope of the invention is not limited to those embodiments. The features, functions, elements and/or properties, and/or combination and combinations of features, functions, elements and/or properties of the track set may be claimed in this or a related application. All subject matter which comes within the meaning and range of equivalency of the claims is to be embraced within the scope of such claims.

What is claimed is:

1. A hand-driven toy, comprising:
a snowboard having an upper surface and a lower surface;
a pair of bindings fixedly secured to the upper surface and defining a boot cavity; and
a pair of boot members each being configured to be releasably secured to the boot cavity of one of the pair of bindings, each of the pair of boot members having a finger opening.

2. The hand-driven toy as in claim 1, wherein an exterior surface of each of the pair of boot members comprises at least one protrusion for receipt in a complementary opening in one of the pair of bindings.

3. The hand-driven toy as in claim 2, wherein the at least one protrusion is a pair of protrusions for receipt in a complementary pair of openings in one of the pair of bindings.

4. The hand-driven toy as in claim 1, wherein the pair of bindings are removably and rotatably secured to the upper surface of the snowboard.

5. The hand-driven toy as in claim 4, wherein an exterior surface of each of the pair of boot members comprises at least one protrusion for receipt in a complementary opening in one of the pair of bindings.

6. The hand-driven toy as in claim 5, wherein the at least one protrusion is a pair of protrusions for receipt in a complementary pair of openings in one of the pair of bindings.

7. The hand-driven toy as in claim 1, wherein each of the pair of bindings further comprise a heel portion and a toe portion for receipt of a corresponding heel portion and toe portion of one of the pair of boot members, the heel portion extending a greater distance from the upper surface of the snowboard than the toe portion.

8. The hand-driven toy as in claim 1, wherein the pair of bindings are each rotatably secured to a protrusion located on the upper surface of the snowboard such that a lower surface of each of the pair of bindings is in a facing spaced relationship with respect to the upper surface of the snowboard.

9. The hand-driven toy as in claim 1, wherein the snowboard and the pair of bindings are configured to be received within a case having a door member pivotally mounted thereto for movement between an open position and a closed position, wherein the open position allows the snowboard in the pair of bindings to be removed from the case and the case defines a terrain portion for the snowboard when the door member is in the closed position.

10. The hand-driven toy as in claim 1, wherein the pair of bindings are removably secured to the snowboard by a fastener.

11. The hand-driven toy as in claim 1, wherein the pair of bindings are removably secured to the snowboard by rotatably engaging a respective mounting feature fixedly secured to the snowboard such that rotational movement of the binding is provided.

12. The hand-driven toy as in claim 11, wherein each of the pair of bindings has an opening configured to allow the mounting feature to be slid therein as the binding moved in a horizontal relationship with respect to a surface of the snowboard, wherein vertical removal of the binding from the snowboard is prevented.

13. The hand-driven toy as in claim 11, wherein each mounting feature of the snowboard has a post portion depending away from an upper surface of the snowboard and an upper engagement portion secured to the post member such that the upper engagement portion is spaced away from a surface of the snowboard and each of the pair of bindings has an opening configured to engage the post member while the upper engagement portion is received within the binding.

14. A method of providing a hand-driven toy, the method comprising:
rotatably mounting a pair of bindings to an upper surface of a snow board; and
releasably securing a pair of boot members into one of the pair of bindings, and each of the pair of boot members having a finger opening.

15. The method as in claim 14, wherein an exterior surface of each of the pair of boot members comprises at least one protrusion for receipt in a complementary opening in one of the pair of bindings.

16. The hand-driven toy as in claim 15, wherein the at least one protrusion is a pair of protrusions for receipt in a complementary pair of openings in one of the pair of bindings.

17. The method as in claim 14, wherein each of the pair of bindings further comprise a heel portion and a toe portion for receipt of a corresponding heel portion and toe portion of one of the pair of boot members, the heel portion extending a greater distance from the upper surface of the snowboard than the toe portion.

18. The method as in claim 14, wherein the pair of bindings are each rotatably secured to a protrusion located on the upper surface of the snowboard such that a lower surface of each of the pair of bindings is in a facing spaced relationship with respect to the upper surface of the snowboard.
